(19) United States
(12) Patent Application Publication
(10) Pub. No.: US 2023/0323839 A1
(43) Pub. Date: Oct. 12, 2023

(54) Systems and Methods for Pressurizing a Propellant Tank With Electrolyzed Products

(71) Applicant: MOMENTUS SPACE LLC, San Jose, CA (US)

(72) Inventors: Joseph Oorebeek, Palo Alto, CA (US); Lee Wilson, San Jose, CA (US)

(21) Appl. No.: 17/704,972

(22) Filed: Mar. 25, 2022

(51) Int. Cl. F02K 9/42; F02K 9/50; F02K 9/56

(52) U.S. Cl. CPC F02K 9/425; F02K 9/50; F02K 9/56

(57) ABSTRACT

A method for managing propellant in a spacecraft is disclosed. The method includes storing liquid propellant in a tank under an operating pressure controlled using a product of chemical decomposition of the propellant. The method may include transferring the liquid propellant out of the tank and chemically decomposing a portion of it using, for example electrolysis. Thus generated one or more gas components may be introduced to the tank to control the operating pressure in the tank.

### FIELD OF THE DISCLOSURE

The present disclosure generally relates to a propellant system of a spacecraft and, more particularly, to controlling propellant tank pressure using a gas product of electrolysis.

### BACKGROUND

With increased commercial and government activity in Near Space, a variety of spacecraft and missions are under development. For example, a spacecraft may be dedicated to delivering payloads such as satellites from one orbit to another, clean up space debris, make deliveries to space stations, etc. In the course of missions, managing the propellant efficiently remains a challenge. In particular, there may be a need to maintain pressure in the propellant tank above the vapor pressure of a liquid propellant, for example, to prevent cavitation within pumps. Furthermore, as propellant is consumed, a gas may be provided to fill the increased vapor volume within a tank. In terrestrial applications, the atmosphere provides a ready source of gas which may be added to the tank through a vent, while gravity can produce hydrostatic loads sufficient to pressurize pumps. Microgravity and vacuum conditions of space, on the other hand, pose special challenges. A pressurant gas can be launched aboard a space vehicle, but there is a cost penalty to any mass so launched.

Generally, in addition to operational requirements, spacecraft-based systems may need to satisfy weight and space requirements. That is, all of the systems may need to fit into specified mass and volume envelopes. Furthermore, proliferation of subsystems and components may increase the probability of failure. Thus, there is a need to maintain propellant pressure (e.g., within an acceptable range) in a manner that reduces weight, space, and/or complexity.

### SUMMARY

An example embodiment of the techniques of this disclosure is a system for managing propellant in a spacecraft. The system includes a tank configured to store liquid propellant (e.g., water) under an operating pressure and a liquid propellant transfer unit configured to transfer the liquid propellant out of the tank. The system further includes a chemical decomposition unit (e.g., an electrolysis unit) configured to chemically decompose a portion of the liquid propellant to generate one or more gas components and a gas transfer unit configured to use at least one of the one or more gas components to control the operating pressure in the tank.

Another example embodiment of these techniques is a method for managing propellant in a spacecraft. The method includes storing liquid propellant in a tank under an operating pressure and transferring the liquid propellant out of the tank. The method further includes chemically decomposing (e.g., electrolyzing) a portion of the liquid propellant transferred out of the tank to generate one or more gas components and using at least one of the one or more gas components to control the operating pressure in the tank.

Yet another example embodiment of these techniques is an apparatus for controlling operating pressure in a tank containing liquid propellant. The apparatus includes a means for transferring the liquid propellant out of the tank, a means for chemically decomposing (e.g., electrolyzing) a portion of the liquid propellant to generate one or more gas components, and a means to control the operating pressure in the tank using at least one of the one or more gas components.

### BRIEF DESCRIPTION OF THE DRAWINGS

FIG. 1 schematically illustrates a portion of a propellant management system of this disclosure configured to control operating pressure within a tank storing liquid propellant using a chemical decomposition product of the propellant.

FIG. 2 illustrates an example embodiment of a chemical decomposition unit using proton exchange membrane (PEM) electrolysis.

FIG. 3 illustrates an example embodiment of a chemical decomposition unit using high temperature electrolysis.

FIG. 4 illustrates a first example embodiment of the system in FIG. 1.

FIG. 5 illustrates a second example embodiment of the system in FIG. 1.

FIG. 6 illustrates a third example embodiment of the system in FIG. 1.

FIG. 7 illustrates a fourth example embodiment of the system in FIG. 1.

FIG. 8 is a block diagram of an example spacecraft, configured for transferring a payload between orbits, in which the propellant managements system of this disclosure may operate.

FIG. 9 illustrates an example method for controlling operating pressure within a tank storing liquid propellant using a chemical decomposition product of the propellant.

### DETAILED DESCRIPTION

Operation of a propellant system of a spacecraft, or space vehicle, is essential to operation of the spacecraft as a whole. In some embodiments, more than one type of propellant is used on the same spacecraft, for example, to supply different types of thrusters. In configurations where at least one of the propellants is stored in liquid form, the propellant system may rely on various components to minimize evaporation of the liquid propellant and the resulting transition of the propellant into a liquid and gas mixture. To that end, a propellant system may include use of a pressurant gas. The propellant system may introduce the pressurant gas directly into a tank which stores the propellant. In other embodiments, the propellant system has a tank configuration with a primary variable volume for storing the propellant (while also containing some quantity of a gas) adjacent to a secondary variable volume for containing the pressurant. As used herein, the term “volume” (e.g., within “variable volume” or “fixed volume”) refers to a volume of space that is bounded (e.g., such that the internal pressure of the volume can be maintained and/or controlled via one or more input and/or output elements, such as a gas inlet, a relief valve, etc.). The primary and secondary variable volumes may be configured as two variable portions of a fixed tank volume. That is, increasing the volume of one portion necessitates decreasing the volume of the other. In any case (i.e., regardless of whether the tank volume is fixed), the primary and secondary variable volumes may be configured to be in reciprocal relationship with each other, such that an increase in the secondary volume decreases the primary volume. In some embodiments, the primary and the secondary variable volumes are separated by a membrane. The secondary volume may be implemented and/or controlled using a bladder, a piston, or any other suitable mechanical component. The propellant system may introduce the pressurant into the secondary variable volume, thereby expanding the secondary variable volume, reducing the primary variable volume, and, consequently, increasing the pressure in the volume storing the liquid propellant.

Whether the propellant system applies the pressurant gas directly or via the secondary volume, as described above, the propellant system needs a supply of the pressurant gas. Storing a tank of pressurant gas on the spacecraft generally adds to the weight envelope and/or the volume envelope of the spacecraft. Moreover, the associated gas handling components and controls generally add complexity to the propellant management system. The present disclosure describes a propellant management system and associated methods which generate the pressurant from the liquid propellant itself using chemical decomposition of the liquid propellant. Embodiments of the described system and/or methods can reduce weight envelope, volume envelope, and/or complexity of the spacecraft while achieving a suitable level of pressurization of the liquid propellant in the propellant tank.

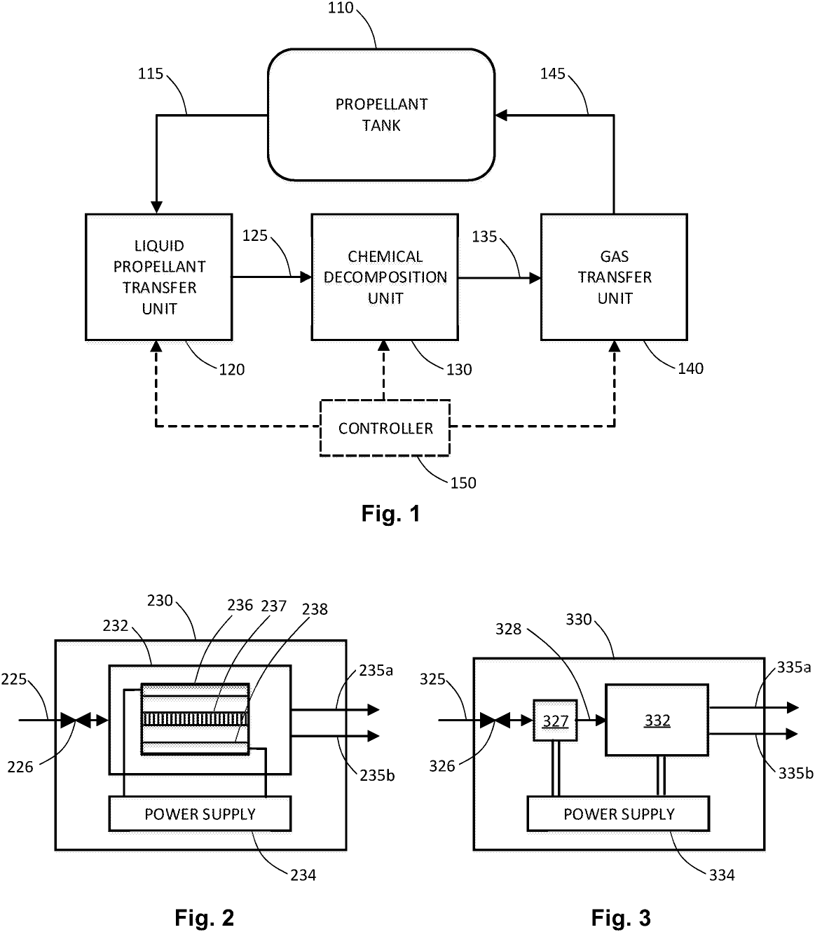

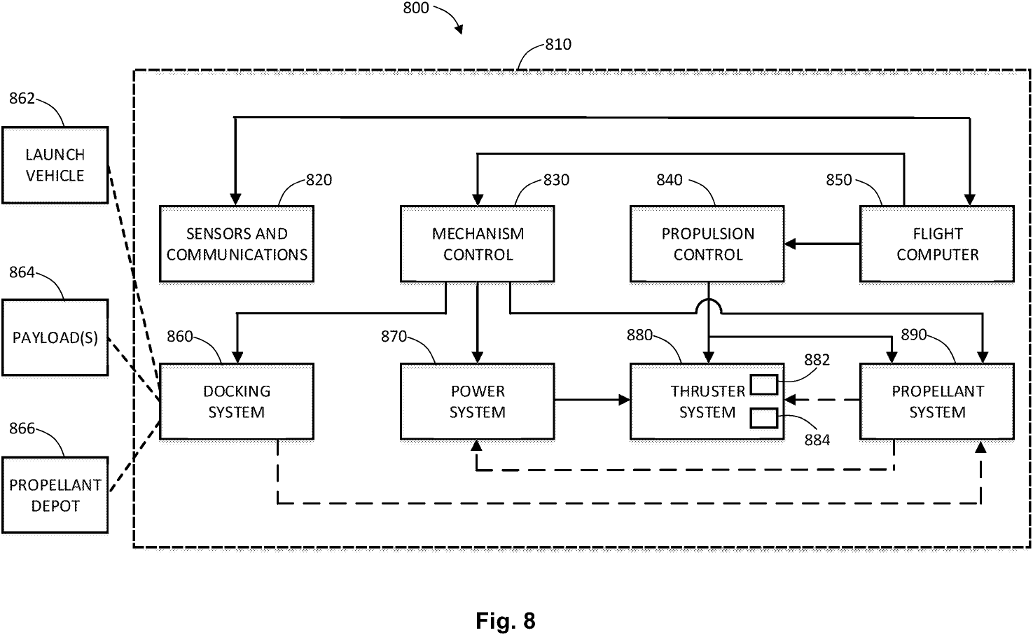

FIG. 1 schematically illustrates a portion 100 of a propellant management system of this disclosure. The propellant management system may operate within a spacecraft, as described above. In the context of the techniques described in the present disclosure, the portion 100 of a propellant system may be referred to as the propellant management system 100 or, simply, the system 100. It shall be recognized that the system 100 is a portion of a larger propellant management system as described, for example, in the context of FIG. 8.

The propellant management system 100 includes a propellant tank 110, or simply tank 110, configured to store liquid propellant in microgravity under an operating pressure. The liquid propellant may be water or hydrazine, for example. In addition to the liquid propellant, the tank 110 may contain a gas under pressure that is greater than the vapor pressure of the liquid propellant at an operating temperature of the tank. The operating temperature of the tank may generally depend on the operating conditions of the spacecraft. In the present disclosure, at least a component of the gas, which may be referred to as a pressurant gas or, simply, a pressurant, is a gas product of chemical decomposition of the liquid propellant. In operation, the system 100 may control an operating pressure in the propellant tank 110 using at least one gas product of chemical decomposition of a portion of the liquid propellant that is withdrawn from the tank 110.

A liquid propellant transfer unit 120 is configured to be in fluidic communication with the tank 110. In operation, the liquid propellant transfer unit 120 may draw at least a portion 125 of a liquid stream 115 of the propellant flowing from the tank 110 and direct the portion 125 of the liquid stream 115 into a chemical decomposition unit 130. The portion 125 of the liquid stream 115 may simply be referred to as liquid stream 125.

A chemical decomposition unit 130 is configured to be in fluidic communication with the liquid propellant transfer unit 120. The chemical decomposition unit 130 is configured to chemically decompose the liquid stream 125 to generate a chemical decomposition product stream 135. The chemical decomposition stream 135 contains at least one gaseous product of chemical decomposition of the propellant.

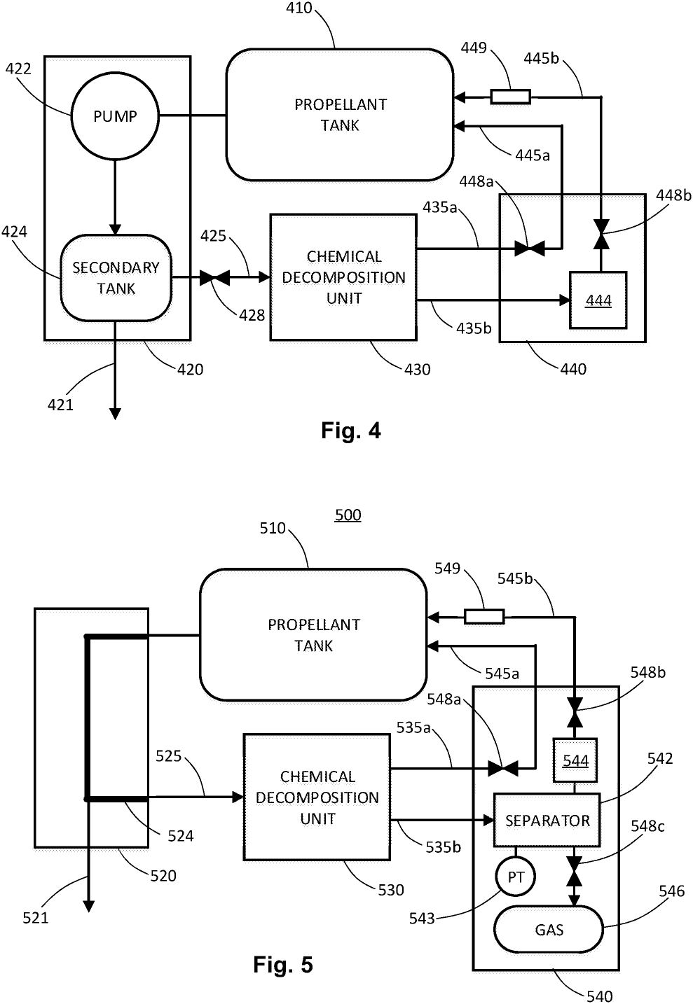

A gas transfer unit 140 is configured to be in fluidic communication with the chemical decomposition unit 130 and with the tank 110. The gas transfer unit 140 is configured to direct one or more gaseous products within the stream 135 into the tank 110. In some embodiments, as described below, particularly in the context of FIGS. 4-6, the system 100 is also configured to direct a remaining portion of the liquid propellant within the stream 135 into the tank 110. Thus, a stream 145 return into the tank 110 may generally include one or more gaseous components of chemical decomposition of the propellant and, additionally, a liquid portion of the propellant flowing out of the chemical decomposition unit 130. It is understood that references herein to a “stream” of any matter (e.g., liquid and gas) may refer to only a single stream (e.g., mixed liquid and gas) or distinct, isolated streams (e.g., a liquid stream and a separate gas stream), unless the context of use clearly indicates one meaning over the other. Furthermore, “streams” may refer to separable fluid components sharing a conduit, and/or flows of fluid in separate conduits.

The system 100 may optionally include a controller 150 configured to control operation of the liquid propellant transfer unit 120, operation of the chemical decomposition unit 130, and/or operation of the gas transfer unit 140. For example, the controller 150 may control the how much of the liquid propellant stream 115 is included in (e.g., diverted to) the stream 125. Additionally or alternatively, the controller 150 may control a rate of chemical decomposition within the chemical decomposition unit 130. Still additionally or alternatively, the controller 150 may control flow rate of one or more portions of the stream 135 back into the propellant tank 110 via the stream 145. Generally, the controller 150 may be implemented using any suitable processing hardware, such as, for example, a digital signal processing (DSP) circuit, an application-specific integrated circuit (ASIC), a field programmable gate array (FPGA), and/or a microprocessor configured to executed software instructions stored in a memory unit. More generally, the controller 150 and/or other control systems interacting with the system 100 may be implemented with any suitable electronic hardware and/or software components.

The tank 110 may be configured to store the propellant as a two-phase mixture in some embodiments and/or under some operating conditions. In other embodiments and/or under other operating conditions, the tank 110 is configured to minimize the amount of the gas phase of the propellant by using a pressurant. The tank 110 may be configured to have a single fixed volume or a variable volume, and may be configured as only a single volume or as primary and secondary volumes in mechanical (but not fluidic) communication with each other. The tank 110 may include inlets, outlets, pressure sensors, relief valves, and/or other components for fluid management. In some embodiments, the tank 110 includes temperature controlled surfaces, capillary transfer components, and/or other suitable features configured for concentrating and/or transferring the liquid propellant within the volume of the tank 110.

The liquid propellant transfer unit 120 may include inlets, outlets, pressure sensors, valves, one or more pumps, one or more accumulation reservoirs or tanks, wicks or other capillary transfer components, and/or other components that enable transfer of the liquid propellant out of the tank 110. The liquid propellant transfer unit 120 may be configured to transfer a portion of the liquid propellant transferred out of the tank 110 to the chemical decomposition unit 130. Furthermore the liquid propellant transfer unit 120 may deliver the remaining portion of the liquid propellant transferred out of the tank 110 to one or more portions of the propellant management system that are distinct from the system portion 100. In particular, the liquid propellant transfer unit 120 may transfer liquid propellant out of the propellant tank 110 for use (consumption) by one or more spacecraft engines or thrusters. The liquid propellant transfer unit 120 may direct the portion 125 and the remainder of the liquid propellant that was transferred out of the tank 110 to the chemical decomposition unit 130 and the rest of the propellant management system, respectively, in a sequential and/or concurrent manner. Over a particular time window of operation (e.g., ranging from a few minutes to multiple days), the liquid propellant transfer unit 120 may divide the liquid propellant transferred out of the propellant tank according to the relative propellant usage requirements of the chemical decomposition unit 130 (or, more generally the portion 100 of the propellant management system) and the remainder of the propellant management system. Within the particular time window, the fraction of the propellant used by the portion 100 of the propellant management system may be multiple orders of magnitude (e.g., 100, 1000, 10⁴, 10⁵, 10⁶, 10⁷, 10⁸, etc.) smaller than the fraction of the propellant used (e.g., consumed) by the remainder of the propellant management system. In other words, the portion of the liquid propellant chemically decomposed to control the operating pressure of the tank 110 may be orders of magnitude, and possibly many orders of magnitude, smaller than the portion of the liquid propellant consumed to generate thrust. Possible configurations of the propellant transfer unit 120 are described below with reference to FIGS. 4 and 5.

The chemical decomposition unit 130 may receive the liquid propellant from the liquid propellant transfer unit 120 via the stream 125. The chemical decomposition unit 130 may, in turn, decompose a portion of the received liquid propellant to generate one or more gas components. If the liquid propellant is water, for example, the chemical decomposition unit 130 may convert the water (H₂O) to oxygen gas (O₂) and hydrogen gas (H₂). In some embodiments, the chemical decomposition unit 130 is configured to chemically decompose the entirety of the liquid propellant received via the stream 125. In other embodiments or operating regimes, the chemical decomposition unit 130 decomposes only a fraction of the received liquid propellant via the stream 125, and pass-through the remainder of the received liquid propellant via the stream 135 to the gas transfer unit 140.

To affect chemical decomposition of the received liquid propellant, the chemical decomposition unit 130 may include an electrolysis unit, as described in more detail below with reference to FIGS. 2 and 3. Additionally or alternatively, the chemical decomposition unit 130 may include a heater. In some embodiments, the chemical decomposition unit 130 uses the heater in conjunction with an electrolysis unit. In other embodiments, the heater contributes to a thermal decomposition of the liquid propellant using, for example, a catalyst. In still other embodiments, the chemical decomposition unit 130 adds a reagent to the liquid propellant to produce a gas product.

The chemical decomposition unit 130 may include any or all of the remaining reagents and products into the stream 135 supplied to the gas transfer unit 140. The chemical decomposition unit 130 may provide the stream 135 as two separate streams in different conduits. That is, the transfer of the stream 135 to the gas transfer unit 140 may be over one or more pipes, hoses, ducts, capillaries, and/or any other suitable conduits. In some embodiments, the chemical decomposition unit 130 vents one or more reagents or products, and/or direct one or more reagents or products to portions of the spacecraft other than the gas transfer unit 140.

The gas transfer unit 140 may receive the stream 135 from the chemical decomposition unit 130 via one or more conduits, as described above. To process the stream 135, the gas transfer unit 140 may include a collection of inlets, outlets, pressure sensors, temperature sensors, valves, one or more pumps, one or more accumulation reservoirs or tanks, etc.

The gas transfer unit 140 uses at least one of the gas components in the stream 135 to control the operating pressure in the tank 110. In some embodiments, the gas transfer unit 140 receives only one of the gas products from the chemical decomposition unit 130 via the stream 135, and passes-through the entirety of the gas directly to the tank 110. The system 100 may then implement the control of the pressure in the propellant tank 110 by controlling the supply of the liquid propellant to the chemical decomposition unit 130 and/or the rate of chemical decomposition within the unit 130. In other embodiments, the gas transfer unit 140 processes and/or directs multiple components of the stream 135. Several examples of possible configurations of the gas transfer unit 140 are discussed below, particularly with reference to FIGS. 4-7.

The controller 150 may be in communicative connection with one or more sensors disposed at (e.g., within) the tank 110, at the liquid propellant transfer unit 120, at the chemical decomposition unit 130, and/or at the gas transfer unit 140. The controller 150 may process measurement data received from the sensors to determine the appropriate action(s) to take. For example, the controller 150 may control valves, heaters, etc., within the system 110 based on the measurement data, in order to carry out the various operations described herein.

In some embodiments, the controller 150 is configured to control a conversion ratio of the liquid propellant in the stream 125 to the one or more gas components in the stream 135. To affect a desired conversion ratio, the controller 150 may be configured to control a rate of propellant flow to the chemical decomposition unit 130. Additionally or alternatively, the controller 150 may be configured to control a rate of decomposition within the chemical decomposition unit 130. The target ratio of conversion may be one (1) in some embodiments. That is, the controller 150 may be configured to convert substantially all of the liquid propellant in the stream 125 to the gas components in the stream 135.

In some embodiments, the controller 150 is distributed among the different portions of the system 100. For example, the liquid propellant transfer unit 120, the chemical decomposition unit 130, and/or the gas transfer unit 140 may include or otherwise be associated with individual controllers. In other embodiments, the controller 150 is implemented as a portion of a more centralized control system, as discussed, for example, with reference to FIG. 8.

FIGS. 2 and 3 schematically illustrate example embodiments of the chemical decomposition unit 130 using electrolysis. FIG. 2 illustrates an example embodiment of the chemical decomposition unit 130 using a proton exchange membrane (PEM) electrolysis. FIG. 3, on the other hand, illustrates an example embodiment of the chemical decomposition unit 130 using steam electrolysis.

In FIG. 2, a chemical decomposition unit 230 may be an embodiment of the chemical decomposition unit 130 of FIG. 1. The chemical decomposition unit 230 may take in an input stream 225 through a valve 226. The input stream 225 may be the input stream 125 from an embodiment of the liquid propellant transfer unit 120. The valve 226 may control the flow rate of the stream 225, based on a control signal, for example, from the controller 150. In some embodiments, a liquid propellant transfer unit (e.g., the liquid propellant transfer unit 120) may control flow rate of the input stream 225, and the valve 226 is omitted.

The chemical decomposition unit 230 includes an electrolysis unit 232 and a power supply 234 electrically connected to the electrolysis unit 232. The power supply 234 may include a battery, a capacitor, a solar cell, a solar collector, a fuel cell, a micro turbine, and/or any other device suitable for generating, storing, and/or supplying power.

In operation, the electrolysis unit 232 may take in the stream 225 containing liquid propellant and generate output streams 235a and 235b. The output streams 235a and 235b may be components of the output stream 135 of the chemical decomposition unit 130 of FIG. 1. In an example embodiment, the stream 235a is a stream of gas, the gas being a decomposition product of electrolysis of the liquid propellant, while the stream 235b is a stream of another gas decomposition product of electrolysis mixed with the remaining liquid propellant. In another embodiment, the electrolysis unit 232 may be configured to fully decompose the liquid propellant in the stream 225, and the output streams 235a, b may each carry solely a respective gas product of the decomposition. To that end, a controller (e.g., controller 150) may control the rate of flow of the liquid propellant to the electrolysis unit 232 or the rate of electrolysis. The controller may control the rate of electrolysis, for example, by controlling the amount of power that the power supply 234 supplies to the electrolysis unit 232.

The electrolysis unit 232 may include a proton exchange membrane 237 (PEM) disposed between an anode 236 and a cathode 238. The PEM 237 may be implemented as a polymer electrolyte membrane, for example. Generally, any membrane conductive to protons, but not conductive to electrons or negatively charged ions, may be used. The PEM 237 may be constructed with pure polymer, composite, or other materials embedded in a polymer matrix. The polymers may be poly aromatic polymers, fully or partially fluorinated polymers, or any other suitable polymers.

In operation, a proton generating reaction may take place at the anode side of the PEM 237 of the electrolysis unit 232. Subsequently, the generated protons may travel toward the cathode 238 of the electrolysis unit 232, recombine with electrons, and form, for example, hydrogen gas (e.g., if the liquid propellant is water or hydrazine). The electrolysis unit 232 may then channel the generated hydrogen gas into an output stream (e.g., the output stream 235a). The propellant management system 100 may then use the generated hydrogen to pressurize the tank 110.

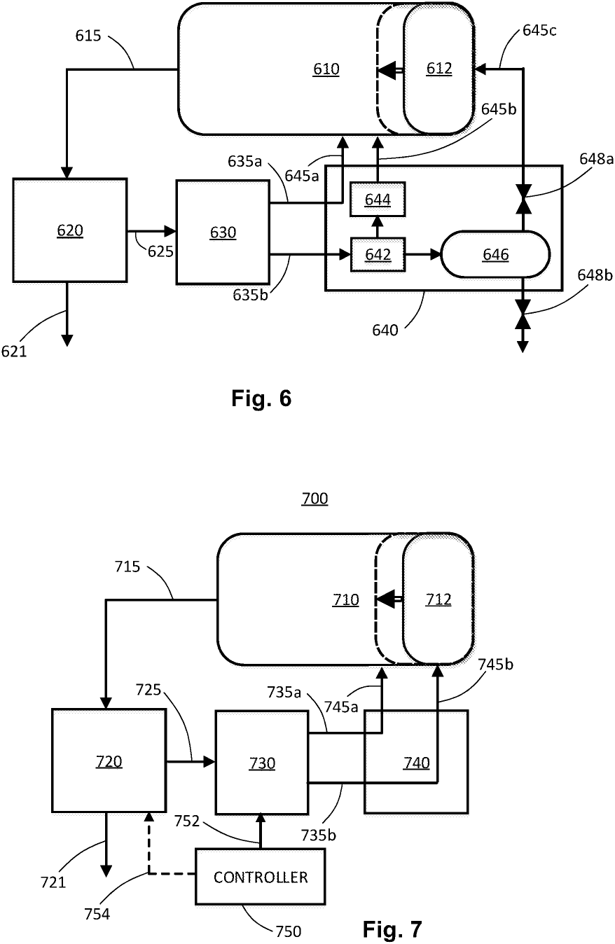

In embodiments where the liquid propellant is water, the anode side reaction produces oxygen gas that may mix with the water stream. The electrolysis unit 232 may channel the oxygen enriched water stream into an output stream (e.g., the output stream 235b). The propellant management system 100, using, for example, the gas transfer unit 140, may recirculate the liquid propellant (water) in the output stream 235b back into the tank 110. Prior to recirculating water into the tank 110, the gas transfer unit 140 may remove oxygen from the water stream. The oxygen removed from the water stream may contribute to pressurizing the propellant tank 110, as described below, particularly with reference to FIGS. 6 and 7.

In embodiments where the liquid propellant is hydrazine, the anode side reaction produces nitrogen gas that may mix with the hydrazine stream. The electrolysis unit 232 may channel the nitrogen enriched hydrazine stream into an output stream (e.g., the output stream 235b). The propellant management system 100, using, for example, the gas transfer unit 140, may recirculate the liquid propellant (hydrazine) in the output stream 235b back into the tank 110. Prior to recirculating hydrazine into the tank 110, the gas transfer unit 140 may remove nitrogen from the hydrazine stream. The nitrogen removed from the hydrazine stream may contribute to pressurizing the propellant tank 110, as described below, particularly with reference to FIGS. 6 and 7.

More generally, techniques described in this disclosure may apply to other liquid propellants. In the context of FIG. 2, the chemical decomposition unit 230 may decompose other liquid propellants with hydrogen as a decomposition product. Even more generally, the chemical decomposition unit 230 may use a solid state membrane selectively conductive for one of the intermediate ionic products of chemical decomposition at either an anode or a cathode in place of the PEM 237 to enable electrolysis.

In FIG. 3, a chemical decomposition unit 330 may be an embodiment of the chemical decomposition unit 130 of FIG. 1. The chemical decomposition unit 330 may be configured for high temperature electrolysis. In the embodiments where the liquid propellant is water, the high temperature electrolysis may be referred to as steam electrolysis.

The chemical decomposition unit 330 includes a heater 327, an electrolysis unit 332, and a power supply 334. The heater 327 is configured to be in thermal communication with an input stream 325, via, for example, a heat exchanger. The power supply 334 may be configured to provide power to the heater 327 as well as to the electrolysis unit 332. In some embodiments, there may be separate power supplies for the heater 327 and the electrolysis unit 332. The power supply 334 may include a battery, a capacitor, a solar cell, a solar collector, a fuel cell, a micro turbine, and/or any other device suitable for generating, storing, and/or supplying power.

In operation, the chemical decomposition unit 330 may take in an input stream 325 through a valve 326. The input stream 325 may be the input stream 125 from an embodiment of the liquid propellant transfer unit 120. The valve 326 may control the flow rate of the stream 325, based on a control signal, for example, from the controller 150. Through the valve 326, the stream 325 carrying the liquid propellant may flow past the heater 327, for example through a heat exchanger. In some embodiments, the input stream 325 may flow directly past the heater 327, without flowing through a valve. In such embodiments a liquid propellant transfer unit (e.g., the liquid propellant transfer unit 120) may control the rate of flow in the stream 325. In any case, the heater 327 may transfer heat to, and thereby vaporize, the input stream 325. A vaporized stream 328 may then flow into the electrolysis unit 332. The electrolysis unit 332 may take in the stream 328 containing vaporized propellant and generate output streams 335a and 335b. The output streams 335a and 335b may be components of the output stream 135 of the chemical decomposition unit 130 of FIG. 1.

In an example embodiment, the stream 335a is a stream of gas, the gas being a decomposition product of electrolysis of the vaporized propellant, while the stream 335b is a stream of another gas decomposition product of electrolysis mixed with the remaining vaporized propellant. In another embodiment, the electrolysis unit 332 is configured to fully decompose the vaporized propellant in the stream 328, and the output streams 335a, b each carry solely a respective gas product of the decomposition. To that end, a controller (e.g., controller 150) may control the rate of flow of the liquid propellant past the heater 327 to the electrolysis unit 332. Simultaneously, the controller may control the amount of heat that the heater 327 transfers to the liquid propellant stream 325, for example, by controlling the amount of power that the power supply 334 supplies to the heater 327. Additionally or alternatively, the controller may control the rate of electrolysis, for example, by controlling the amount of power that the power supply 334 supplies to the electrolysis unit 332.

The electrolysis unit 332 may be configured for high temperature electrolysis. To that end, the electrolysis unit 332 may include an anode, a cathode, and a solid-state electrolyte membrane. The anode and the cathode may be porous to allow the flow of the vaporized propellant and the product gases produced by electrolysis. The electrolyte may be made of zirconia, ceramic, or another suitable material.

In embodiments where the liquid propellant is water, the anode side reaction produces oxygen gas. The cathode side reaction may produce hydrogen mixed with steam. The electrolysis unit 332 may channel oxygen into one output stream (e.g., the output stream 335a) and the hydrogen enriched water vapor stream into another output stream (e.g., the output stream 335b). In some embodiments, the chemical decomposition unit 330 may condense the vapor, generating an output stream (e.g., the output stream 335b) of hydrogen mixed in water. The propellant management system 100, using, for example, the gas transfer unit 140, may recirculate the liquid propellant (water) in the output stream 335b back into the tank 110. The mixed-in hydrogen may then serve as the pressurant. Alternatively, prior to recirculating water into the tank 110, the gas transfer unit 140 may remove hydrogen from the water stream, and introduce the removed hydrogen into the tank 110 separately to control the pressure in the tank 110. Likewise, the oxygen generated by steam electrolysis may contribute to pressurizing the propellant tank 110, as described below, particularly with reference to FIGS. 6 and 7. Additionally or alternatively, at least some of the oxygen generated by electrolysis may be used (e.g., by another portion of the overall propellant system) for another purpose, such as, for example, as an oxidizing agent for chemical propulsion.

FIG. 4 illustrates an example embodiment 400 of the system 100 in FIG. 1. The embodiment 400 includes a liquid propellant transfer unit 420 in fluidic connection with a propellant tank 410 (e.g., the propellant tank 110) and a chemical decomposition unit 430 (e.g., the chemical decomposition unit 130, 230, or 330). The liquid propellant transfer unit 420 of the embodiment 400 includes a pump 422 and a secondary tank 424 in fluidic connection with each other. The secondary tank 424, which is configured to accumulate a portion of the liquid propellant transferred from the tank 410, may also be referred to as an accumulation tank.

The liquid propellant transfer unit 420 may be configured to direct a portion of the liquid propellant drawn from the propellant tank 410 into an output stream 421. The overall propellant system, within which the system 400 is configured to operate, may direct the output stream 421 for use (e.g., consumption) by one or more spacecraft engines and/or for other uses. The liquid propellant transfer unit 420 may direct a remaining portion of the liquid propellant via a stream 425 (e.g., stream 125) flowing through a valve 428 (which may be integrated into the liquid propellant transfer unit 420) to the chemical decomposition unit 430. An average flow rate of the stream 425 may be a fraction of the average flow rate of the stream 421 over a suitable time period, as discussed above.

In operation, the pump 422 may generate a pressure gradient across the fluidic connections of the system 400, with pressure downstream of the pump 422 higher than the pressure within the propellant tank 410. It should be noted, referring back to FIG. 1, that a pressure gradient across the fluidic connections of the system 100 may be generated by a pump disposed at a different location within the system 100. For example, in some embodiments the pump is disposed between the liquid propellant transfer unit 120 and the chemical decomposition unit 130, at the chemical decomposition unit 130, between the chemical decomposition unit 130 and the gas transfer unit 140, or between the gas transfer unit 140 and the propellant tank 110. Furthermore, multiple pumps may be distributed throughout an embodiment of the system 100.

In operation, liquid propellant may accumulate at the secondary tank 424 at a higher pressure than within the propellant tank 410. A controller (e.g., the controller 150) may simultaneously or alternately direct the propellant flow from the secondary tank 424 into the stream 421 or the stream 425 flowing into the decomposition unit 430.

The chemical decomposition unit 430 may decompose the stream 425 of the liquid propellant into two output streams 435a and b, which, for example, may be streams 235a and b, or 335a and b. The output stream 435a may substantially be a gas product of the chemical decomposition within the unit 430. The gas transfer unit 440 may direct the gas product in the stream 435a into the tank 410 via a valve 448a to pressurize the propellant within the tank 410. A controller (e.g., controller 150) may control the valve 448a based on a pressure measured at the propellant tank 410 or another suitable point in fluidic communication with the tank 410. The gas transfer unit 440 may direct the gas within the stream 435a via additional valves into a storage tank or through a vent to maintain suitable flow rate of the stream 445a.

The output stream 435b may be a mixture of the remaining liquid propellant after the decomposition within the chemical decomposition unit 430 and a second gas decomposition product (e.g., hydrogen, oxygen, nitrogen, depending on the type of electrolysis and liquid propellant, as described above). The gas transfer unit 400 may include a recirculation unit 444 that directs the flow of the liquid propellant back into the tank 410 via a stream 445b flowing through a valve 448b and a restrictor 449. In some embodiments, the recirculation unit 444 may include a pump, an accumulator tank, and/or other components for processing the flow of the mixture containing propellant. For example, in the case of steam electrolysis within the chemical decomposition unit 430, the recirculation unit 444 may include a condenser, condensing the steam form of the propellant back into the liquid form. The restrictor 449 may be configured to limit the flow of the liquid propellant via the stream 445b into the propellant tank 410.

FIG. 5 illustrates another example embodiment 500 of the system 100 in FIG. 1. The embodiment 500 includes a liquid propellant transfer unit 520 in fluidic connection with a propellant tank 510 (e.g., the propellant tank 110) and a chemical decomposition unit 530 (e.g., the chemical decomposition unit 130, 230, or 330). The liquid propellant transfer unit 520 of the embodiment 500 includes a capillary transfer device 524. The capillary transfer device 524 may direct liquid propellant from the tank 510 to the output stream 521 and the output stream 525. The overall propellant system, within which the system 500 is configured to operate, may direct the output stream 521 for use (e.g., consumption) by spacecraft engines and/or for other uses. A pump may be disposed along the stream 521 to draw propellant from the capillary transfer device 524. The capillary transfer device 524 may include branches for directing the liquid propellant simultaneously into the streams 521 and 525. The sizes of the branches may be configured to at least in part set the ratio of flow rates between the two output streams 521 and 525. Additionally or alternatively, thermal gradients, pressure gradients, and/or mechanical actuation may drive the liquid propellant along capillary channels within the capillary transfer device 524. In some embodiments, referring to FIG. 1, a capillary transfer device within the liquid propellant transfer unit 120 may be configured to only direct liquid propellant into the chemical decomposition unit 130, while, for example, one or more pumps may draw the liquid propellant from the tank 110 for other uses within the spacecraft system.

In operation, the stream 525 from the liquid propellant transfer unit 520 may flow into the chemical decomposition unit 530. The chemical decomposition unit 530 may chemically decompose the input stream 525 into the output streams 535a, containing a gas product, and 535b, containing a mixture of the propellant and another gas product of the decomposition. The system 500 may direct the streams 535a and b into a gas transfer unit 540, which may be an implementation of the gas transfer unit 140 in FIG. 1. The gas transfer unit 540 may include a separator 542 in fluidic communication with a pressure transducer 543, a liquid propellant recirculation unit 544, a gas storage tank 546, and a set of valves 548a-c. The gas transfer unit 540 may be configured to deliver streams 545a and 545b. Stream 545a contains a gas from the stream 535a, and stream 545b contains remaining liquid propellant substantially separated, using the separator 542, from a gas product of the chemical decomposition (e.g., the second gas product, distinct from the gas in stream 535a).

In some embodiments, the separator 542 is a de-bubbler, configured to remove the bubbles of gas product of chemical decomposition from the liquid propellant. The separator 542 may use, for example, a degassing semi-permeable membrane to affect the separation. In other embodiments the separator 542 separates the propellant in gas phase from the gas product of decomposition, using distillation or another suitable process. The separator 542 may direct the propellant portion into the recirculation unit 544 and a gas portion into the gas tank 546 via the valve 548c. In some embodiments, the gas transfer unit 540 vents the gas from the separator 542 (e.g., into space) or directs the gas out of the system 500, and the gas tank 546 is omitted. The recirculation unit 544 may direct the liquid propellant via the valve 548b and the optional restrictor 549 into the propellant tank 510. In some embodiments, using, for example, high-temperature electrolysis, the recirculation unit 544 includes a condensation section for converting gas phase propellant back into the liquid phase.

A controller, such as the controller 150, may receive an indication of pressure from the pressure transducer 543, and based on the received indication of pressure control the valve 548c, the rate of decomposition in the chemical decomposition unit 530, and/or venting of the gas decomposition product separated in the separator. In some embodiments, the controller may control the flow rate of the stream 525 into the chemical decomposition unit 530 based at least in part on the signal from the pressure transducer 543.

The overall propellant management system, within which the system 500 is configured to operate, may use the gas accumulated in the gas tank 546 as a pressurant, an oxidation agent, or in another manner.

While FIG. 5 shows an embodiment 500 in which the system 100 includes both (1) a liquid propellant transfer unit (520) that uses capillary transfer, and (2) a gas transfer unit (540) that stores gas, it is understood that other embodiments may include the gas transfer unit 540 with a different type of liquid propellant transfer unit (e.g., without capillary transfer), or may include the liquid propellant transfer unit 520 with a different type of gas transfer unit (e.g., without gas storage). In some embodiments, for example, the gas transfer unit 540 depicted in FIG. 5 in instead used with the liquid propellant transfer unit 420 depicted in FIG. 4 (i.e., with the liquid propellant transfer unit 420 using a pump rather than capillary transfer), in order to achieve higher pressures for the gas stored in the gas tank 546 than would be feasible with capillary transfer.

FIG. 6 illustrates another example embodiment 600 of the system 100 in FIG. 1. The illustrated embodiment 600 includes a variable volume 612 within the propellant tank. The variable volume 612 may be implemented with a membrane, a bladder, a piston, or any other suitable mechanical component. The variable volume 612 is a portion of the total volume of the tank 610. In a sense, when the total volume of the tank 610 is fixed, the variable volume 612 subdivides the volume of the tank 610 into two interdependent volumes, i.e. a primary volume and a secondary volume. The primary volume may contain the liquid propellant, while the secondary volume (i.e., volume 612) may contain a pressurant. As the secondary volume expands, the primary volume contracts.

The system 600 may include, in fluidic communication with each other, a liquid propellant transfer unit 620 (e.g., unit 120, 420, or 520), a chemical decomposition unit 630 (e.g., unit 130, 230, or 330), and a gas transfer unit 640 (e.g., unit 140 or 540). A stream 615 (e.g., stream 115) flows into the liquid propellant transfer unit 620. A stream 625 (e.g., stream 125) flows out of the liquid propellant transfer unit 620 and into a chemical decomposition unit 630. A stream 621 flows out of the unit 620 (e.g., for consumption by spacecraft thrusters).

The chemical decomposition unit 630 may produce output streams 635a and b, which may be components of stream 135 and/or streams flowing out of the chemical decomposition unit 230, 330, 430, or 530 of FIGS. 2-5. The stream 635a may carry a gas product of decomposition, while the stream 635b may carry another gas product of decomposition mixed with the remnants of the propellant. As similarly described with reference to the gas transfer unit 540 in FIG. 5, the gas transfer unit 640 may include a separator 642, a recirculation unit 644 for returning the remnants of liquid propellant to the tank 610, and a gas tank 646. The gas tank 646 may contain the gas product of the decomposition of the propellant separated from the remnants of the propellant by the separator 642. A valve 648a of the gas transfer unit 640 may control the flow of the gas from the gas tank 646 into the variable volume 612 of the tank 610. In some embodiments the gas product separated by the separator 642 may be directed directly into the variable volume 612 obviating the tank 646. A valve 648b may vent the gas from the tank 646 into the space environment, or, alternatively, direct the gas in the tank 646 for another use within the spacecraft.

In the system embodiment 600, the gas transfer unit 640 may direct three streams 645a-c into the tank 610. The stream 645a may direct the gas product of chemical decomposition (e.g., hydrogen) within the stream 635a directly into the primary volume of the gas tank 610 to pressurize the stored liquid propellant. The gas transfer unit 640, may likewise direct the liquid propellant stream 645 from the recirculation unit 644 directly into the primary volume of the gas tank 610. On the other hand, the gas transfer unit 640 may direct the gas stream 645c of the gas separated from the remnants of the propellant into the variable (secondary) volume 612c. Directing the second gas product into a separate volume 612 (e.g., a bladder) within the tank 610, rather than mixing the two gas products directly within the tank 610, avoids chemical recombination of the two gas products, while using both gas products to pressurize the tank 610.

FIG. 7 illustrates another example embodiment 700 of the system in FIG. 1. The system embodiment 700 is similar to the embodiment 600 in that both use two components of the chemical decomposition of the propellant to pressurize a tank 710. Similar to the embodiment 600, the embodiment 700 may add one gas component directly to the volume of the tank 710 holding the propellant, while adding another to a variable volume 712.

Unlike the embodiment 600, however, the embodiment 700 is configured to eliminate the equipment for returning the liquid propellant back to the tank 710 by fully decomposing the liquid propellant in a chemical decomposition unit 730 (e.g., unit 130, 230, or 330). As in the embodiments described above, the embodiment 700 may include, in fluidic communication with each other, a liquid propellant transfer unit 720 (e.g., unit 120, 420, 520 or 620), and a gas transfer unit 740 (e.g., unit 140). A stream 715 (e.g., stream 115) may flow into the liquid propellant transfer unit 720. A stream 725 (e.g., stream 125) may flow out of the liquid propellant transfer unit 720 and into the chemical decomposition unit 730. A stream 721 may flow out of the unit 720, for example, for consumption by spacecraft thrusters. The gas transfer unit 740 may be simpler than the gas transfer unit 640 in that the unit 740 need not handle the liquid propellant. The gas streams 735a and b flowing into the gas transfer unit may be substantially the same as the gas streams 745a and b flowing out of the gas transfer unit and, respectively, into the primary volume of the tank 710 and the secondary variable volume 712 of the tank. The gas conversion unit 740 may include sensors to measure the flow rates and compositions of the streams 735a and b. In other implementations, the gas transfer unit 740 may include components for controlling the gas flow, as described above with reference to FIGS. 4-6.

To fully decompose the liquid propellant, the system 700 may include a controller 750 (e.g., controller 150) that controls the rate of chemical decomposition within the chemical conversion unit 730 and/or the supply of liquid propellant to the unit 730 via the stream 725. In embodiments where the chemical conversion unit 730 implements the chemical conversion using electrolysis, the controller 750 may control the rate of electrolysis by setting an appropriate voltage to or current through the electrolysis unit (e.g., as in unit 232 or 332). In embodiments where the chemical conversion unit 730 implements the chemical conversion using thermal breakdown in a reactor within the chemical conversion unit 730, the controller may control reactor temperature, the surface temperature, or the amount of a catalyst surface within the reactor.

The controller 750 may control the flow rate of the stream 725 by controlling valves, pump speeds, or, in the case of capillary transfer, thermal gradient or mechanical forces acting on the capillary material, for example.

The controller 750 may control the rate of decomposition in the chemical decomposition unit 730 and/or the flow rate to the unit 730 based on one or more process parameter sensors (e.g., flow rate, composition, and/or temperature sensors) disposed at the liquid propellant transfer unit 720, chemical conversion unit 730, and/or gas transfer unit 740.

FIG. 8 is a block diagram of a spacecraft 800 configured for transferring a payload between orbits in which portions of a propellant management system (e.g., system 100, 400, 500, 600, or 700) may operate. The propellant use, the environmental condition of the tank 110, and, consequently, the operation of the system 100, may interact with a variety of parameters of operation of the spacecraft 800.

The spacecraft 800 includes a number of systems, subsystems, units, or components disposed in, on, and/or coupled to a housing 810. The subsystems of the spacecraft 800 may include sensors and communications components 820, mechanism control 830, propulsion control 840, a flight computer 850, a docking system 860 (for attaching to a launch vehicle 862, one or more payloads 864, a propellant depot 866, etc.), a power system 870, a thruster system 880 that includes a primary propulsion (main) thruster subsystem 882 and an attitude adjustment thruster subsystem 884, and a propellant system 890 which may include the system 100, 400, 500, 600, or 700 of the present disclosure. Furthermore, any combination of subsystems, units, or components of the spacecraft 800 involved in determining, generating, and/or supporting spacecraft propulsion (e.g., the mechanism control 830, the propulsion control 840, the flight computer 850, the power system 870, the thruster system 880, and the propellant system 890) may be collectively referred to as a propulsion system of the spacecraft 800.

The sensors and communications components 820 may include a number of sensors and/or sensor systems for navigation (e.g., imaging sensors, magnetometers, inertial motion units (IMUs), Global Positioning System (GPS) receivers, etc.), temperature, pressure, strain, radiation, and other environmental sensors, as well as radio and/or optical communication devices to communicate, for example, with a ground station, and/or other spacecraft. The sensors and communications components 820 may be communicatively connected with the flight computer 850, for example, to provide the flight computer 850 with signals indicative of information about spacecraft position and/or commands received from a ground station.

The flight computer 850 may include one or more processors, a memory unit, computer readable media, to process signals received from the sensors and communications components 820 and determine appropriate actions according to instructions loaded into the memory unit (e.g., from the computer readable media). Generally, the flight computer 850 may be implemented using any suitable processing hardware, such as, for example, a digital signal processing (DSP) circuit, an application-specific integrated circuit (ASIC), a field programmable gate array (FPGA), and/or a microprocessor configured to executed software instructions stored in a memory unit. More generally, the flight computer 850 may be implemented with any suitable electronic hardware and/or software components. The flight computer 850 may generate control messages based on the determined actions and communicate the control messages to the mechanism control 830 and/or the propulsion control 840. For example, upon receiving signals indicative of a position of the spacecraft 800, the flight computer 850 may generate a control message to activate one of the thruster subsystems 882, 884 in the thruster system 880 and send the message to the propulsion control 840. The flight computer 850 may also generate messages to activate and direct sensors and communications components 820. For example, the flight computer 850 may interact with the control module 260 (which may include the control unit 100) as described above.

The docking system 860 may include a number of structures and mechanisms to attach the spacecraft 800 to a launch vehicle 862, one or more payloads 864, and/or a propellant refueling depot 866. The docking system 860 may be fluidicly connected to the propellant system 890 to enable refilling the propellant from the propellant depot 866. Additionally or alternatively, in some embodiments at least a portion of the propellant may be disposed on the launch vehicle 862 and outside of the spacecraft 800 during launch. The fluidic connection between the docking system 860 and the propellant system 890 may enable transferring the propellant from the launch vehicle 862 to the spacecraft 800 upon delivering and prior to deploying the spacecraft 800 in orbit.

The power system 870 (which may include the power supplies 234, 334) may include components for collecting solar energy, generating electricity and/or heat, storing electricity and/or heat, and delivering electricity and/or heat to the thruster system 880. To collect solar energy, the power system 870 may include solar panels with photovoltaic cells, solar collectors or concentrators with mirrors and/or lenses, or a suitable combination of devices. In the case of using photovoltaic devices, the power system 870 may convert the solar energy into electricity and store it in energy storage devices (e.g., lithium ion batteries, fuel cells, etc.) for later delivery to the thruster system 880 and other spacecraft components. In some embodiments, the power system 880 may deliver at least a portion of the generated electricity directly (i.e., bypassing storage) to the thruster system 880 and/or to other spacecraft components. When using a solar concentrator, the power system 870 may direct the concentrated (having increased irradiance) solar radiation to photovoltaic solar cells to convert to electricity. In other embodiments, the power system 870 may direct the concentrated solar energy to a solar thermal receiver or simply, a thermal receiver, that may absorb the solar radiation to generate heat. The power system 870 may use the generated heat to power a thruster directly and/or to generate electricity using, for example, a turbine or another suitable technique (e.g., a Stirling engine). The power system 870 then may use the electricity directly for generating thrust or storing electrical energy.

The thruster system 880 may include a number of thrusters and other components configured to generate propulsion or thrust for the spacecraft 800. Thrusters may generally include main thrusters in the primary propulsion subsystem 882 that are configured to substantially change speed of the spacecraft 800, or as attitude control thrusters in the attitude control thruster subsystem 884 that are configured to change direction or orientation of the spacecraft 800 without substantial changes in speed.

One or more thrusters in the primary propulsion subsystem 882 may be microwave-electro-thermal (MET) thrusters. In a MET thruster cavity, an injected amount of propellant (e.g., delivered via the liquid propellant transfer unit 120) may absorb energy from a microwave source (that may include one or more oscillators) included in the thruster system 880 and, upon partial ionization, further heat up, expand, and exit the MET thruster cavity through a nozzle, generating thrust.

Another one or more thrusters in the primary propulsion subsystem 882 may be solar thermal thrusters. In one embodiment, propellant in a thruster cavity acts as the solar thermal receiver and, upon absorbing concentrated solar energy, heats up, expands, and exits the nozzle generating thrust. In other embodiments, the propellant may absorb heat before entering the cavity either as a part of the thermal target or in a heat exchange with the thermal target or another suitable thermal mass thermally connected to the thermal target. In some embodiments, while the propellant may absorb heat before entering the thruster cavity, the primary propulsion thruster subsystem 882 may add more heat to the propellant within the cavity using an electrical heater or directing a portion of solar radiation energy to the cavity.

Other types of thrusters may also be used. For example, the primary propulsion subsystem 882 may also, or instead, include one or more combustion thrusters that consume one or more electrolysis products (e.g., electrolysis products generated by an electrolysis unit that is larger scale, and perhaps utilizes a different electrolysis technique, than the electrolysis unit discussed above in connection with generating the tank pressurant).

Thrusters in the attitude adjustment subsystem 884 may use propellant that absorbs heat before entering the cavities of the attitude adjustment thrusters in a heat exchange with the thermal target or another suitable thermal mass thermally connected to the thermal target. In some embodiments, while the propellant may absorb heat before entering thruster cavities, the thrusters of the attitude adjustment thruster subsystem 884 may add more heat to the propellant within the cavity using corresponding electrical heaters. Likewise, propellant may be evaporated in heat exchangers prior to the supply of propellant into high temperature electrolysis units (e.g., unit 332). Thus, the heater 327 of FIG. 3, for example, may interact with other thermal elements of the spacecraft 800.

The propellant system 890 may store the propellant for consumption in the thruster system 880. The propellant may include water, hydrogen peroxide, hydrazine, ammonia, or another suitable substance. The propellant may be stored on the spacecraft in solid, liquid, and/or gas phase. To that end, the propellant system 890 may include one or more tanks (e.g., tank 110), including, in some embodiments, deployable tanks. To move the propellant within the spacecraft 800, and to deliver the propellant to one of the thrusters, the propellant system 890 may include one or more pumps, valves, and pipes. The propellant may also store heat and/or facilitate generating electricity from heat, and the propellant system 890 may be configured, accordingly, to supply propellant to the power system 870. In some embodiments, one or more electrolysis units (e.g., unit 232 and/or 332) of this disclosure may be configured to run in reverse as fuel cells to generate electricity.

The mechanism control 830 may activate and control mechanisms in the docking system 860 (e.g., for attaching and detaching a payload or connecting with an external propellant source), the power system 870 (e.g., for deploying and aligning solar panels or solar concentrators), and/or the propellant system 890 (e.g., for changing the configuration of one or more deployable propellant tanks). Furthermore, the mechanism control 830 may coordinate interaction between subsystems, for example, by deploying a tank in the propellant system 890 to receive propellant from an external propellant source connected to the docking system 860.

The propulsion control 840 may coordinate the interaction between the thruster system 880 and the propellant system 890, for example, by activating and controlling electrical components (e.g., a microwave source) of the thruster system 840 and the flow of propellant supplied to thrusters by the propellant system 890. Additionally or alternatively, the propulsion control 840 may direct the propellant through elements of the power system 870. For example, the propellant system 890 may direct the propellant to absorb the heat (e.g., at a heat exchanger) accumulated within the power system 870. Vaporized propellant may then drive a power plant (e.g., a turbine, a Stirling engine, etc.) of the power system 870 to generate electricity. Additionally or alternatively, the propellant system 890 may direct some of the propellant to charge a fuel cell within the power system 890. Still further, the attitude adjustment thruster subsystem 184 may directly use/consume the heated propellant to generate thrust.

The subsystems of the spacecraft may be merged or subdivided in different embodiments. For example, a single control unit may control mechanisms and propulsion. Alternatively, dedicated controllers may be used for different mechanisms (e.g., a pivot system for a solar concentrator), thrusters (e.g., a MET thruster), valves, etc. In the preceding discussion, a controller may refer to any portion or combination of the mechanism control 830 and/or propulsion control 840.

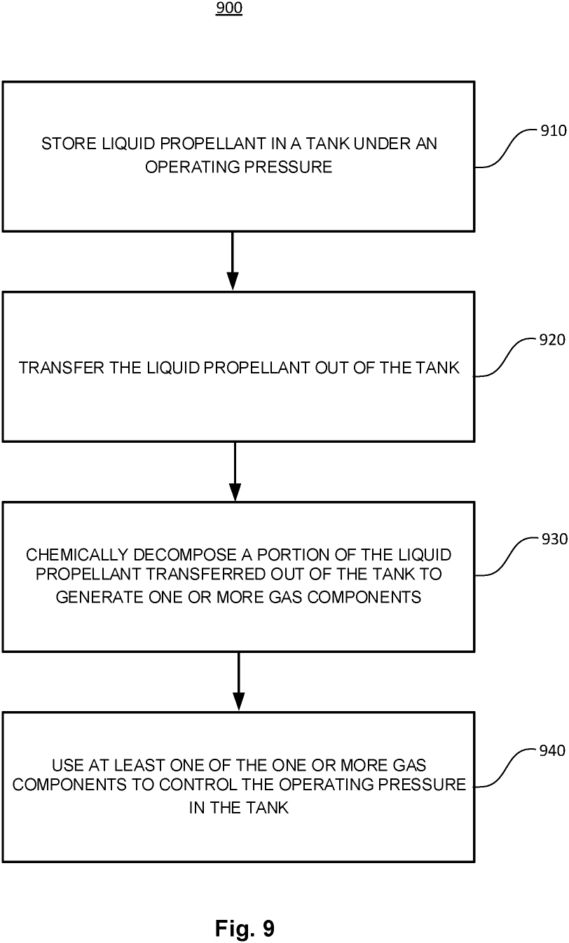

FIG. 9 illustrates an example method 900 for controlling operating pressure within a tank storing liquid propellant using a chemical decomposition product of the propellant. The method 900 may be performed by a propellant management system such as system 100 (e.g., any one of embodiments 400, 500, 600, or 700).

At block 910, the method 900 includes storing liquid propellant (e.g., water or hydrazine) in a tank (e.g., tank 110) under an operating pressure. The operating pressure may be controlled (e.g., by the controller 150) using at least one of one or more gas decomposition products, e.g., as described with reference to system 100 or embodiment 400, 500, 600, or 700). The tank may include a single, fixed volume containing the propellant, or two variable volumes inversely related, as described, for example, with reference to FIGS. 6 and 7.

At block 920, the method 900 includes transferring the liquid propellant out of the tank (e.g., using the liquid propellant transfer unit 120 or the embodiments of FIGS. 4-7). The method 900 may further include delivering a portion of the transferred propellant to a chemical decomposition unit (e.g., unit 130 of FIG. 1 or the embodiments of FIGS. 2-7). Delivering the portion of the liquid propellant may be accomplished using one or more pumps (e.g., using pump 422 of FIG. 4), accumulation tanks (e.g., tank 424 of FIG. 4), and/or capillary transfer devices (e.g., device 524 of FIG. 5).

At block 930, the method 900 may include chemically decomposing a portion of the liquid propellant (e.g., within unit 130 of FIG. 1 or the embodiments of FIGS. 2-7) transferred out of the tank to generate one or more gas components (e.g., hydrogen and oxygen or nitrogen as described above). The decomposition may be accomplished, for example, by electrolysis (e.g., using units 232 and 332 of FIGS. 2 and 3, respectively) or thermal decomposition, with or without the help of additional reagents and/or catalysts. The electrolysis may use a PEM (e.g., PEM 237) as described with reference to FIG. 2. Alternatively, the electrolysis may be high temperature electrolysis, e.g., as described with reference to FIG. 3. The method 900 implementation with high temperature electrolysis may include vaporizing the liquid propellant by heating (e.g., using the heater 327 of FIG. 3) the liquid propellant, and performing electrolysis on the vaporized propellant (e.g., using unit 332 of FIG. 3).

The method 900 may further include controlling a conversion ratio of the liquid propellant to the two gas components by controlling a rate of electrolysis using, for example, controller 150 or 750 of FIGS. 1 and 7, respectively.

The method 900 may further include measuring pressure (e.g., using the pressure transducer 543 of FIG. 5) of the one of the gas components separated (e.g., by the separator 542 of FIG. 5) from the liquid propellant, and based on the measured pressure, venting the gas component (e.g., through the valve 648b of FIG. 6). Additionally or alternatively, the method 900 may include directing the gas component into a gas storage tank (e.g., using the valve 548c and into the tank 546, as shown in FIG. 5 and described above).

At block 940, the method 900 includes using at least one of the one or more gas components to control the operating pressure in the tank. To that end, one or more gas products of the decomposition at block 930 may be introduced back into the tank as described above with reference to FIGS. 1, 3-7. One of the gases may be hydrogen, introduced into the tank in direct contact with the propellant. Additionally or alternatively, one of the gases may be oxygen introduced into a variable volume (e.g., volume 612 or volume 712 of FIGS. 6 and 7, respectively) of the tank (e.g., tank 610 or 710 of FIGS. 6 and 7, respectively).

What is claimed is:

1. A method for managing propellant in a spacecraft, the method comprising:
storing liquid propellant in a tank under an operating pressure;
transferring the liquid propellant out of the tank;
chemically decomposing a portion of the liquid propellant transferred out of the tank to generate one or more gas components; and
using at least one of the one or more gas components to control the operating pressure in the tank.

2. The method of claim 1, wherein:
chemically decomposing a portion of the liquid propellant to generate one or more gas components includes generating two gas components by electrolysis, and
the at least one of the one or more gas components includes at least one of the two gas components generated by electrolysis.

3. The method of claim 2, wherein generating two gas components by electrolysis includes
using a proton exchange membrane (PEM).

4. The method of claim 2, further comprising:
vaporizing the liquid propellant by heating the liquid propellant; and
wherein generating the two gas components by electrolysis includes generating the two gas components by high temperature electrolysis on vaporized propellant.

5. The method of claim 2, further comprising:
controlling a conversion ratio of the liquid propellant to the two gas components by controlling a rate of electrolysis.

6. The method of claim 1, wherein:
transferring the liquid propellant out of the tank uses capillary action.

7. The method of claim 1, further comprising:
separating a remaining portion of the liquid propellant from one of the one or more gas components; and
returning the remaining portion of the liquid propellant separated from the one of the one or more gas components into the tank.

8. The method of claim 7, further comprising:
measuring pressure of the one of the one or more gas components separated from the liquid propellant; and
based on the measured pressure, i) venting the one of the one or more gas components, or ii) directing the one of the one or more gas components into a gas storage tank.

9. The method of claim 1, wherein:
the one or more gas components include hydrogen; and
controlling the operating pressure of the tank includes directing the hydrogen into the tank in contact with the liquid propellant.

10. The method of claim 9, wherein:
the one or more gas components include oxygen; and
controlling the operating pressure of the tank includes controlling a variable volume of the tank by directing a flow rate of the oxygen.

11. A system for managing propellant in a spacecraft, the system comprising:
a tank configured to store liquid propellant under an operating pressure;
a liquid propellant transfer unit configured to transfer the liquid propellant out of the tank;
a chemical decomposition unit configured to chemically decompose a portion of the liquid propellant to generate one or more gas components; and
a gas transfer unit configured to use at least one of the one or more gas components to control the operating pressure in the tank.

12. The system of claim 11, wherein:
the chemical decomposition unit includes an electrolysis unit.

13. The system of claim 12, wherein:
the electrolysis unit includes a PEM.

14. The system of claim 12, wherein:
the chemical decomposition unit includes a heater configured to vaporize the portion of the liquid propellant.

15. The system of claim 11, further comprising
a recirculation unit configured to return a remainder of the portion of the liquid propellant to the tank.

16. The system of claim 11, further comprising:
a degassing unit configured to separate a remainder of the one or more gas components from a remainder of the portion of the liquid propellant; and
a recirculation unit configured to return to the tank the remainder of the portion of the liquid propellant without the separated remainder of the one or more gas components.

17. The system of claim 11, wherein:
the liquid propellant transfer unit includes a pump configured to generate a pressure gradient across the chemical decomposition unit.

18. The system of claim 11, wherein:
the liquid propellant transfer unit includes an accumulator configured to accumulate the liquid propellant outside of the tank; and
the chemical decomposition unit is configured to receive the portion of the liquid propellant from the accumulator.

19. The system of claim 11, further comprising:
a controller configured to control a conversion ratio of the liquid propellant to the one or more gas components by controlling i) a rate of propellant flow to the chemical decomposition unit, and/or ii) a rate of decomposition within the chemical decomposition unit.

20. An apparatus for controlling operating pressure in a tank containing liquid propellant, comprising:
a means for transferring the liquid propellant out of the tank;
a means for chemically decomposing a portion of the liquid propellant to generate one or more gas components; and
a means to control the operating pressure in the tank using at least one of the one or more gas components.

21. The apparatus of claim 20, further comprising:
a means for controlling i) a rate of propellant flow to the means for chemically decomposing the portion of the liquid propellant, and/or ii) a rate of decomposition within the means for chemically decomposing the portion of the liquid propellant, wherein the means for controlling causes the portion of the liquid propellant to be fully converted into the one or more gas components.
